(19) United States
(12) Patent Application Publication
(10) Pub. No.: US 2009/0282061 A1
(43) Pub. Date: Nov. 12, 2009

(54) IMAGE FORMING APPARATUS AND METHOD TO DISPLAY FILES HAVING IDENTIFIERS

(75) Inventors: Kwang-soo HA, Seoul (KR); Hye-heon Jung, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/329,760

(22) Filed: Dec. 8, 2008

(30) Foreign Application Priority Data
May 9, 2008 (KR) 2008-43603

(51) Int. Cl. G06F 17/30

(52) U.S. Cl. 707/100; 707/E17.005

(57) ABSTRACT

An image forming apparatus which adds an identifier to at least one file includes a display panel unit to display at least one file having an identifier to distinguish the at least one file from at least one general file, and a control unit to display the at least one file having the identifier distinctly from the at least one general file on the display panel unit. Accordingly, the user can retrieve a desired file more rapidly, increasing user convenience.

### CROSS-REFERENCE TO RELATED APPLICATIONS

This application claims priority under 35 U.S.C. §119(a) from Korean Patent Application No. 10-2008-0043603, filed on May 9, 2008, in the Korean Intellectual Property Office, the disclosure of which is incorporated herein in its entirety by reference in its entirety.

### BACKGROUND OF THE INVENTION

1. Field of the Invention

The present general inventive concept relates to an image forming apparatus and a method to display files having identifiers. More particularly, the present general inventive concept relates to an image forming apparatus to manage and display files using identifiers and a method to display identifier added files.

2. Description of the Related Art

With the development of electronic technology, a wide variety of image forming apparatuses have been introduced onto the market and are widely used, including printers, scanners, copiers, facsimile machines, and multifunction peripherals having functions of at least two of the aforementioned devices.

Functions of image forming apparatuses such as storing or outputting documents have become widespread using a hard disk drive (HDD) or a universal serial bus (USB) flash memory without connecting the image forming apparatus to a computer. Jobs performed by the image forming apparatus such as printing, copying, faxing, and scanning can be stored in an HDD or a USB flash memory. In order to store a file generated by a conventional image forming apparatus in a storage medium, the folder or the file is named using the date or time when the scanning is performed or by direct input by a user.

However, as a capacity of storage media has been increasing rapidly, a quantity of files to be managed has been increasing exponentially. Therefore, when retrieving a file to be printed directly from a storage medium using a Document Box function or a USB direct print function, a complex folder structure may make retrieving the file difficult for the user. In particular, in a narrow display environment such as a 2-line liquid crystal display (LCD), there are problems with retrieving a folder and documents belonging to the folder.

FIGS. 1A, 1B, and 2 are drawings illustrating a conventional method to retrieve a file.

As illustrated in FIG. 1A, when a file scanned using a USB scanning function by an image forming apparatus 30 is stored in a USB memory 20, the date and time when scanning is performed are stored with the folder and the file as illustrated in blocks 21 and 22. Accordingly, when the user retrieves a particular file from among the files stored in the USB memory 20, the user must open up the folders which have been named based on the scanning date one by one. In addition, there is also difficulty in retrieving a file stored using a personal computer 10.

As illustrated in FIG. 1B, when a file is stored in an HDD of the image forming apparatus 30, a certain box and a file 31 are generated and stored. If the user wishes to retrieve a particular file, the user must open up the boxes one by one.

FIG. 2 is a flow chart illustrating a process of retrieving a file from the image forming apparatus 30 of FIG. 1A.

As illustrated in FIG. 2, the user sequentially retrieves folders having names including a scanning date (operations 41 and 42), retrieves the files from the folder (operations 43 and 44), and selects and prints a desired file (operation 45). In this case, the user must repeat this process even when the same file is printed frequently, which causes an inconvenience.

Therefore, an amount of time and/or effort to access a desired file in a folder needs to be reduced when the respective file stored in a storage medium is retrieved using a multifunction peripheral or a printer, and files having similar characteristics need to be displayed distinctively, so that user convenience can be increased.

### SUMMARY OF THE INVENTION

The present general inventive concept provides an image forming apparatus which effectively manages and displays files having identifiers, and a method to display files having identifiers.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus, including a display panel unit to display at least one file having an identifier to distinguish the at least one file from at least one general file, and a control unit to display the at least one file having the identifier distinctly from the at least one general file on the display panel unit.

The at least one file may be stored in at least one of a storage unit of the image forming apparatus and an external storage device which is connectable to the image forming apparatus.

The image forming apparatus may further include an input unit, wherein if a command to add an identifier is input through the input unit, the control unit adds the identifier to the at least one file, and if a command to perform an operation is input through the input unit, the control unit performs the operation.

The control unit may display at least one file having a same identifier so as to form a group.

The control unit may display a preset icon at one side of a file name of the at least one file having the identifier.

The control unit may display preview information corresponding to the at least one file.

The identifier may be added according to a preset reference.

The preset reference may be at least one of input by a user, a use history, and a file generated by a preset device.

The identifier may be tag information to be readable or writable by the image forming apparatus.

The image forming apparatus may further include a wheel navigation key to comprise a selecting function and a rotation function, and to retrieve and select at least one file from among a plurality of files using at least one of the selecting function and the rotation function.

The foregoing and/or other aspects and utilities of the present general inventive concept may also be achieved by providing a a method to display a file having an identifier in an image forming apparatus, the method including adding an identifier to at least one file, distinguishing between the at least one file having the identifier and at least one general file, and displaying the at least one file having the identifier distinctly from the at least one general file.

The at least one file may be stored in at least one of a storage unit of the image forming apparatus and an external storage device to be connectable to the image forming apparatus.

If a command to add an identifier or a command to perform an operation is input, the identifier may be added to the at least one file, or the operation is performed.

At least one file having the same identifier may be displayed so as to form a group.

A preset icon may be displayed at one side of a file name of the at least one file having the identifier.

The method may further include displaying preview information area corresponding to the at least one file.

The identifier may be added according to a preset reference.

The identifier may be tag information to be readable or writable by the image forming apparatus.

The method may further include retrieving and selecting at least one file from among a list of files using at least one of a selecting function and a rotation function of a wheel navigation key.

The foregoing and/or other aspects and utilities of the present general inventive concept may also be achieved by providing an identifier adding device, including an operation performance unit to perform a preset operation, and a control unit to generate and add a preset identifier to a file generated by the preset operation.

The operation may be at least one of printing, copying, scanning, faxing, and storing, and the identifier may be a single identifier corresponding to at least one of a type of operation, a manufacturing company, and a device name.

The foregoing and/or other aspects and utilities of the present general inventive concept may also be achieved by providing an image forming system including a storage unit to store a plurality of files, an input unit to select at least one of a plurality of identifiers to correspond with one or more of the plurality of files, a control unit to identify the files based at least on the identifiers corresponding to the files, and to arrange the files in an order based on the corresponding identifiers thereto, and a display unit to display the files in an order based on the corresponding identifiers thereto.

The foregoing and/or other aspects and utilities of the present general inventive concept may also be achieved by providing an image forming method including selecting at least one of a plurality of identifiers to correspond with one or more of a plurality of files, identifying the files based at least on the identifiers corresponding to the files, and arranging the files in an order based on the corresponding identifiers thereto.

### BRIEF DESCRIPTION OF THE DRAWINGS

These and/or other aspects and utilities of the present general inventive will become apparent and more readily appreciated from the following description of the embodiments, taken in conjunction with the accompanying drawings of which:

FIGS. 1A, 1B, and 2 are drawings illustrating a conventional method to retrieve a file;

FIG. 3 is a schematic block diagram illustrating a configuration of an image forming apparatus according to an exemplary embodiment of the present general inventive concept;

FIG. 4 is a schematic block diagram illustrating a configuration of an image forming apparatus according to an embodiment of the present general inventive concept;

FIG. 5 is a drawing illustrating in detail a file storing function of the external memory which is connected to an image forming apparatus of FIG. 4;

FIG. 6 is a schematic block diagram illustrating a configuration of an image forming apparatus according to an embodiment of the present general inventive concept;

FIG. 7 is a drawing illustrating in detail a file storing function of the image forming apparatus of FIG. 6;

FIGS. 8 and 9 are drawings illustrating formats in which files having identifiers distinguished according to a preset reference are displayed;

FIG. 10 is a schematic block diagram illustrating a configuration of an image forming apparatus according to an embodiment of the present general inventive concept;

FIG. 11 is a drawing illustrating a panel unit constituting the image forming apparatus of FIG. 10;

FIGS. 12A to 12C are drawings illustrating a method to retrieve, select, and output a file using the panel unit of FIG. 11;

FIGS. 13A to 13C and 14A to 14D are drawings illustrating a method to add a favorite file using the panel unit of FIG. 11;

FIG. 15 is a block diagram illustrating a configuration of an identifier adding apparatus according to an exemplary embodiment of the present general inventive concept; and

FIGS. 16 and 17 are flow charts illustrating a method to display files having identifiers according to an exemplary embodiment of the present general inventive concept.

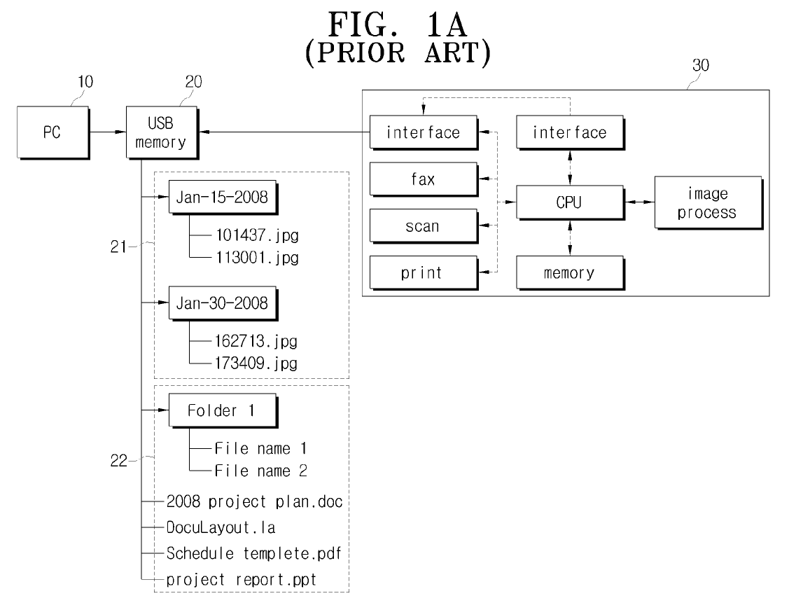

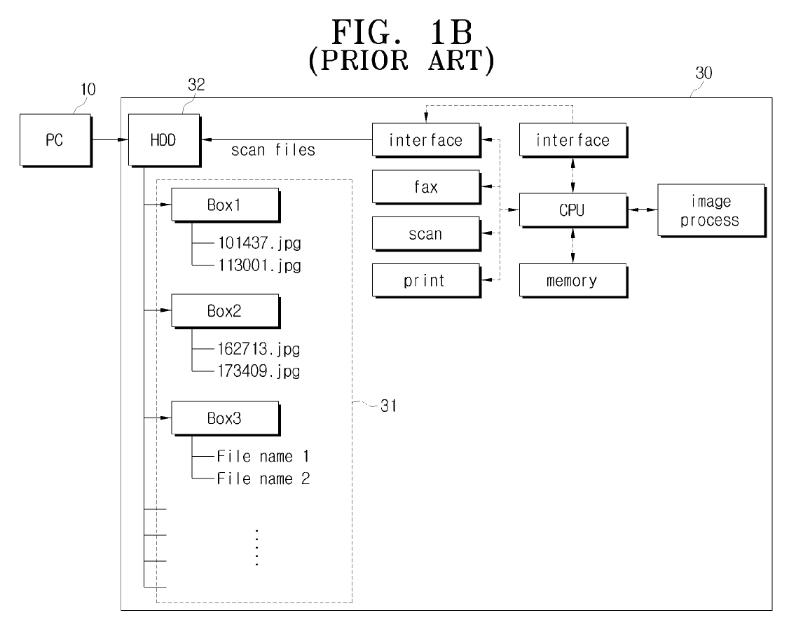

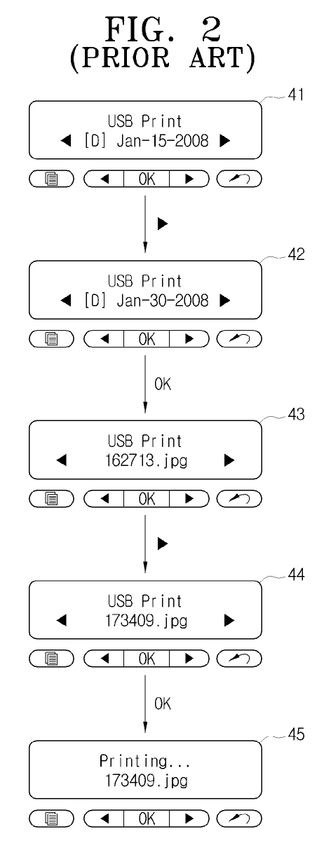

### DETAILED DESCRIPTION OF THE PREFERRED EMBODIMENTS

Reference will now be made in detail to the present embodiments of the present general inventive concept, examples of which are illustrated in the accompanying drawings, wherein like reference numerals refer to like elements throughout. The embodiments are described below in order to explain the present general inventive concept by referring to the figures.

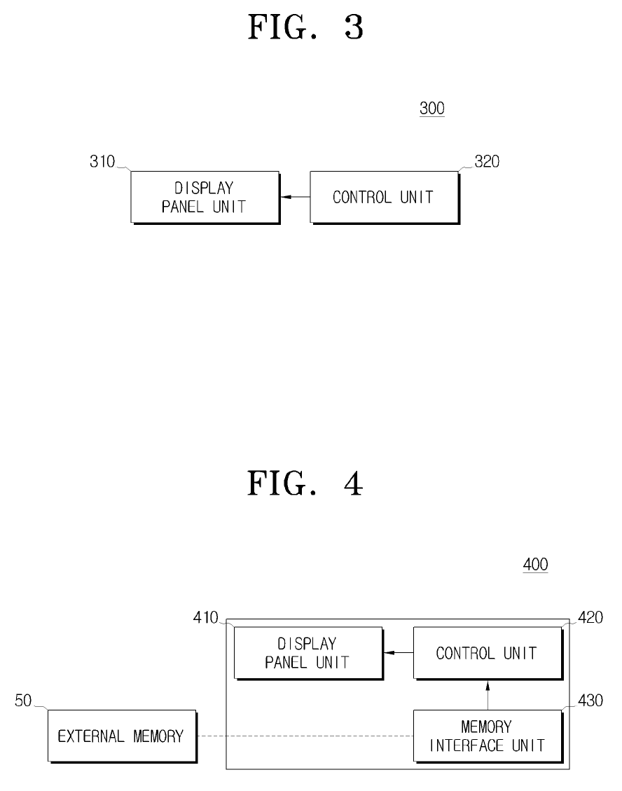

FIG. 3 is a schematic block diagram illustrating a configuration of an image forming apparatus according to an exemplary embodiment of the present general inventive concept. The image forming apparatus 300 includes a display panel unit 310 and a control unit 320. The image forming apparatus 300 may be one of various types of image forming apparatuses, including printers, scanners, copiers, facsimile machines, and multifunction peripherals having functions of at least two of the aforementioned apparatuses.

The display panel unit 310 displays at least one general file and at least one identifier added file. The display panel unit 310 may be a liquid crystal display (LCD), a cathode-ray tube (CRT), a plasma display panel (PDP), or an organic light emitting diode (OLED) display.

The identifier represents tag information which can be read or written by the image forming apparatus 300. The identifier may be added according to a preset reference, for example, according to files set according to input by the user, favorite files of the user, and files processed by a particular device (scanning files, printing files, and copying files). However, this is just an exemplary embodiment, and can be modified or set by the user.

The display panel unit 310 displays menus regarding a variety of functions and messages which are provided by the image forming apparatus 100.

The control unit 320 controls the display panel unit 310 to display files having the same identifier which are distinct from other files among files.

More specifically, the control unit 320 controls the display panel unit 310 so that among the files, the files having the same identifier are displayed as a group.

Alternatively, the control unit 320 may control the display panel unit 310 to display the same icon on one side of the files having the same identifier from among the files.

Alternatively, the control unit 320 may control the display panel unit 310 to display preview information of each of the files.

FIG. 4 is a schematic block diagram illustrating a configuration of an image forming apparatus according to an embodiment of the present general inventive concept. The image forming apparatus 400 includes a display panel unit 410, a control unit 420, and a memory interface unit 430. A detailed description of components of FIG. 4 which correspond to the components illustrated in FIG. 3 is not repeated here.

The memory interface unit 430 enables an external memory 50 to be connected to the image forming apparatus 400. The external memory 50 may be any of diverse types of memory which may be connected to the image forming apparatus 400, such as a USB memory, a portable memory such as a secure digital (SD) or compact flash (CF) card, a cell phone, a digital camera, a personal computer, or a server.

If the external memory 50 is connected to the memory interface unit 430, the control unit 420 displays files stored in the external memory 50 on the display panel unit 410.

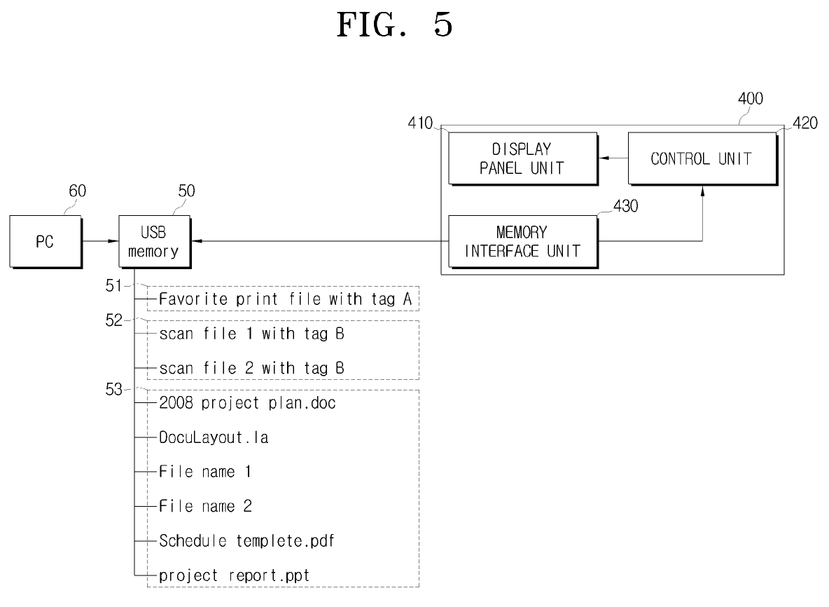

FIG. 5 is a drawing illustrating in detail a file storing function of the external memory 5 which is connected to the image forming apparatus 400 of FIG. 4. For convenience of description, it is assumed that the external memory 50 of FIG. 4 is a USB memory and the external device 60 is a personal computer (PC).

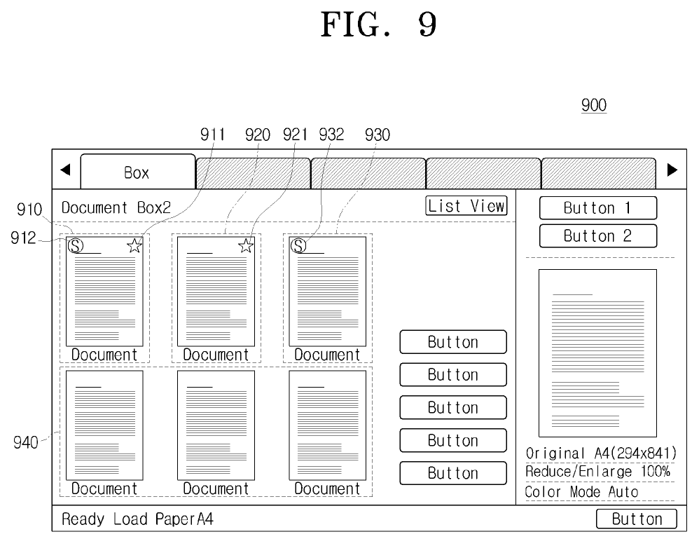

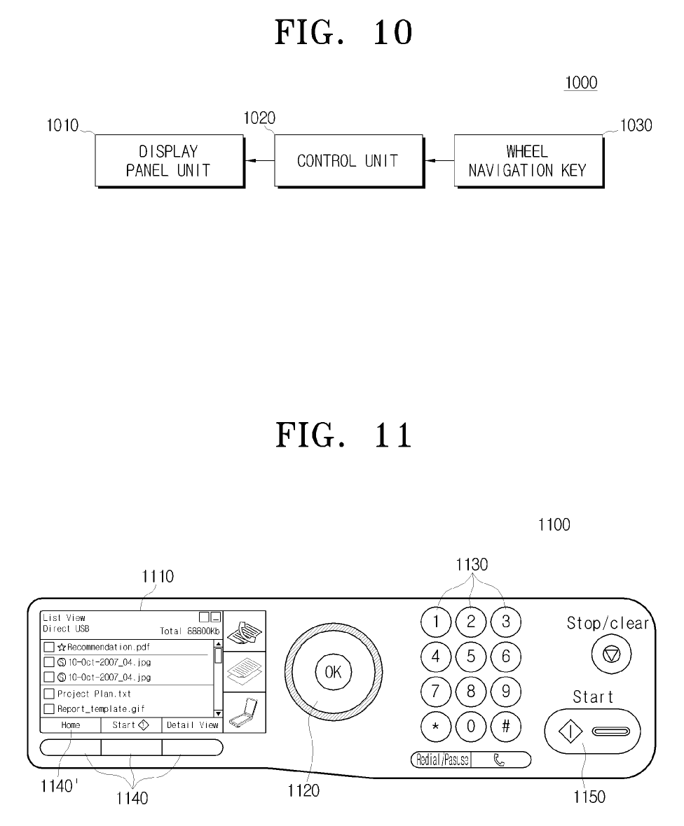

The USB memory 50 may store files transmitted from the PC 60 or the image forming apparatus 400. In this case, the files transmitted from the PC 60 or the image forming apparatus 400 to the USB memory 50 may be stored with identifiers, for example, identifiable tag information. In greater detail, a favorite file 51 may be a file having a first identifier (tag A), and a scan file 52 which is generated by scanning the image forming apparatus 400 may be a file having a second identifier (tag B). In addition, there may be general files 53 having no identifiers. The formats of displaying such files 51, 52, and 53 will be described below with reference to FIGS. 9 and 10.

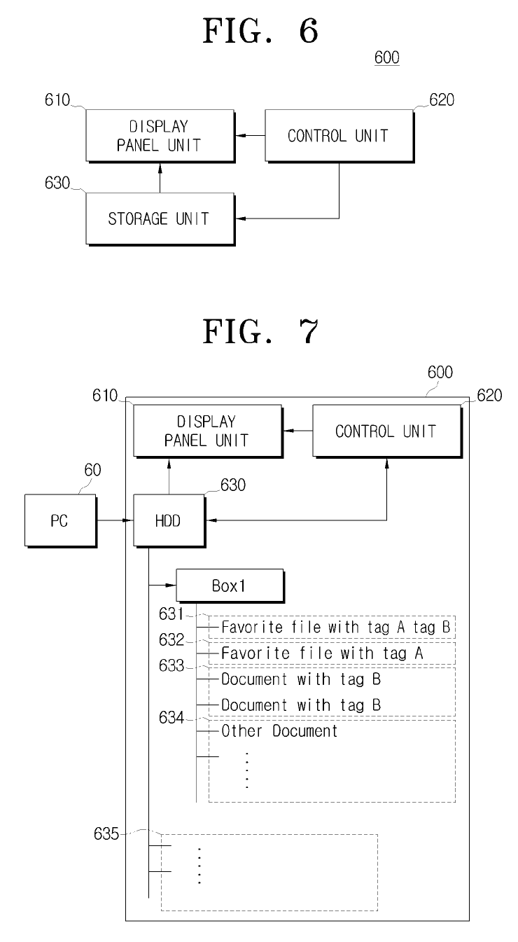

FIG. 6 is a schematic block diagram illustrating a configuration of an image forming apparatus according to an embodiment of the present general inventive concept. The image forming apparatus 600 includes a display panel unit 610, a control unit 620, and a storage unit 630. A detailed description of components of FIG. 46 correspond to the components illustrated in FIG. 3 is not repeated here.

The storage unit 630 stores files which are processed by the image forming apparatus 600 or transmitted from an external device. The storage unit 630 may be a hard disk drive (HDD), or another type of memory device instead of an HDD.

An input unit (not illustrated) receives user commands to perform diverse functions of the image forming apparatus 600. For example, the input unit receives a user command to call files stored in the storage unit 630.

If a user command to call files stored in the storage unit 630 is input, the control unit 620 displays the files on the display panel unit 610.

FIG. 7 is a drawing illustrating in detail a file storing function of the image forming apparatus 600 of FIG. 6. For convenience of description, it is assumed that the storage unit 630 of FIG. 6 is an HDD and the external device 60 is a PC.

The storage unit 630 may store files which are transmitted from the PC 60 or processed by the image forming apparatus 600. In this case, the files which are transmitted from the PC 60 or processed by the image forming apparatus 600 may be stored with identifiers, for example, identifiable tag information. In greater detail, favorite files 631 and 632 may be files having a first identifier (tag A), and scan files 633 which are generated by scanning the image forming apparatus 600 may be files having a second identifier (tag B). In this case, the file 631 may have the first identifier (tag A) and the second identifier (tag B). In addition, there may be general files 634 and 635 having no identifiers. The formats used to display such files 631 to 635 will be described below with reference to FIGS. 9 and 10.

Hereinbelow, for convenience of description, it is assumed that files having the first identifier (tag A) are favorite files which are set up according to the user's taste, and files having the second identifier (tag B) are files scanned by the image forming apparatus 300, 400, or 600 according to an exemplary embodiment of the present general inventive concept.

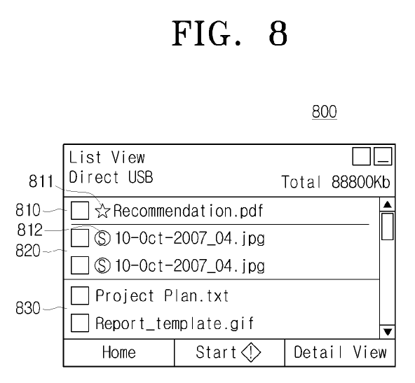

FIGS. 8 and 9 are drawings illustrating formats used to display files having identifiers which are distinguished according to a preset reference.

With reference to FIG. 8, an image forming apparatus 800 including files having the first identifier (tag A), files having the second identifier (tag B), and files having no identifier to form separate groups are displayed on distinct areas 810, 820, and 830 respectively. An icon ⋆ is displayed on one side of the file name of the files having the first identifier (tag A), and an icon \textcircled{s} is displayed on one side of the file name of the files having the second identifier (tag B), so that the files having the identifier can be distinguished from other files. The form of icon used can be modified appropriately.

In this exemplary embodiment, a group of files having the first identifier (tag A) are positioned at the top, the icon ⋆ is displayed on one side of the file name of files having the first identifier (tag A), a group of files having the second identifier (tag B) are positioned under the group of files having the first identifier (tag A), and a group of files having no identifier are positioned at the bottom, but this is merely an exemplary embodiment. The position of each group can be appropriately modified by the user.

With reference to FIG. 9, an image forming apparatus 900 includes preview areas corresponding to each of the files that are displayed, the icons ⋆ 911 and 921 are displayed on preview areas 910 and 920 of the files having the first identifier (tag A), and the icons \textcircled{s} 912 and 932 are displayed on preview areas 910 and 930 of the files having the second identifier (tag B). Accordingly, the preview information of the files having identifiers can be distinct from preview information 940 of the general files having no identifiers. In this exemplary embodiment, the preview information does not display the file names, but display the identifier icons ⋆ and \textcircled{s}. Displaying the file names together with the identifier icons is possible.

FIG. 10 is a schematic block diagram illustrating a configuration of an image forming apparatus according to an embodiment of the present general inventive concept. The image forming apparatus 1000 includes a display panel unit 1010, a control unit 1020, and a wheel navigation key 1030. A detailed description of components of FIG. 10 which correspond to the components illustrated in FIG. 3 is not repeated here.

The wheel navigation key 1030 includes a selecting function and a rotating function, and retrieves and selects at least one file from among the displayed files using at least one of the selecting function and the rotation function. The wheel navigation key 1030 may include a 360° rotating wheel, a jog shuttle, and a jog dial. The wheel navigation key 1030 can be replaced with direction keys (not illustrated) to perform the functions of the wheel navigation key 1030.

FIG. 11 is a drawing illustrating a panel unit 1100 constituting the image forming apparatus 1000 of FIG. 10.

As illustrated in FIG. 11, the display panel unit 1110 is disposed on a left side of the panel unit 1100, the wheel navigation key 1120 is disposed in a middle of the panel unit 1100, and a key input unit 1130 and a start key 1150 is disposed on a right side of the panel unit 1100.

Keys 1140 are formed under the display panel unit 1110, and area 1140′ representing functions of the keys 1140 is formed on one portion of the display panel unit 1110. The functions of the keys 1140 can be modified when necessary, and if so, the modified functions are displayed on the area 1140′.

Hereinbelow, a method to retrieve and selecting a file using the panel unit 1100 of FIG. 11 and a method to add identifiers to files are described.

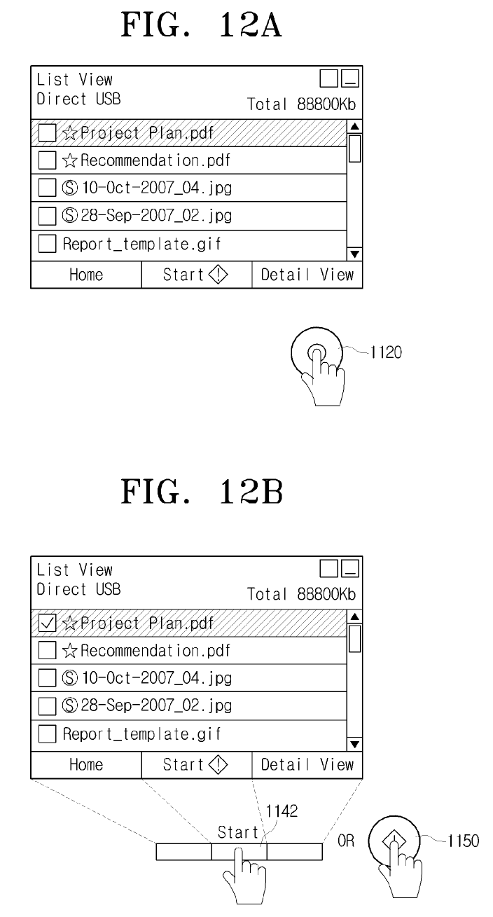

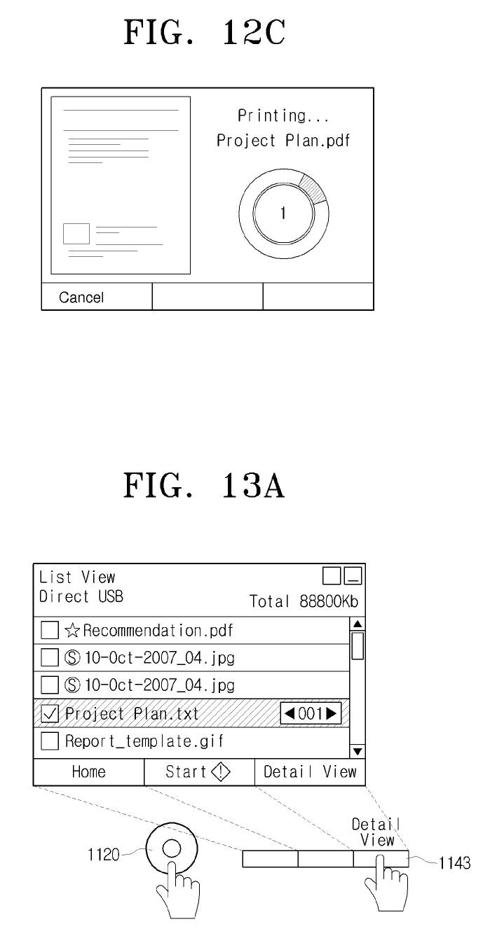

FIGS. 12A to 12C are drawings illustrating a method to retrieve, select, and output a file using the panel unit 1100 of FIG. 11.

As illustrated in FIG. 12A, the user can retrieve a desired file using the wheel navigation key 1120. A file (⋆ Project Plan.pdf) which has been set most recently to be a favorite file by the user is displayed at the top of the list. As a result, when the user wishes to print the most recently set favorite file, the user can search for and print the desired file with a minimal number of operations.

If the user selects ⋆ Project Plan.pdf, the file which is displayed at the top of the list, using a start key 1142 or 1150 as illustrated in FIG. 12B, the selected file is printed as illustrated in FIG. 12C.

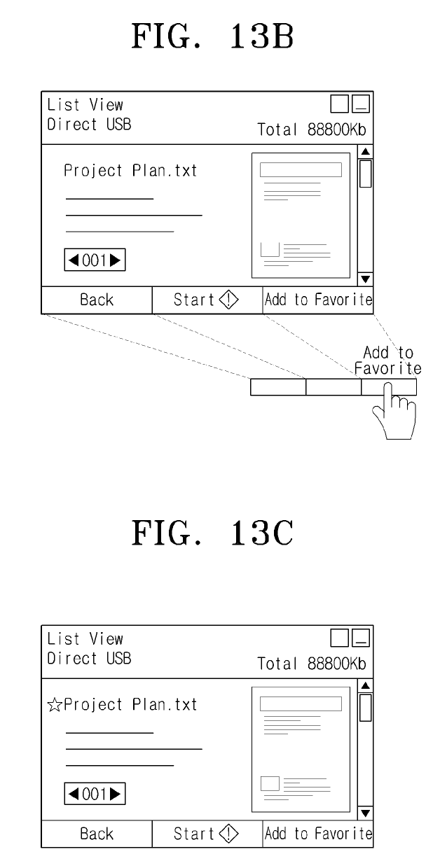

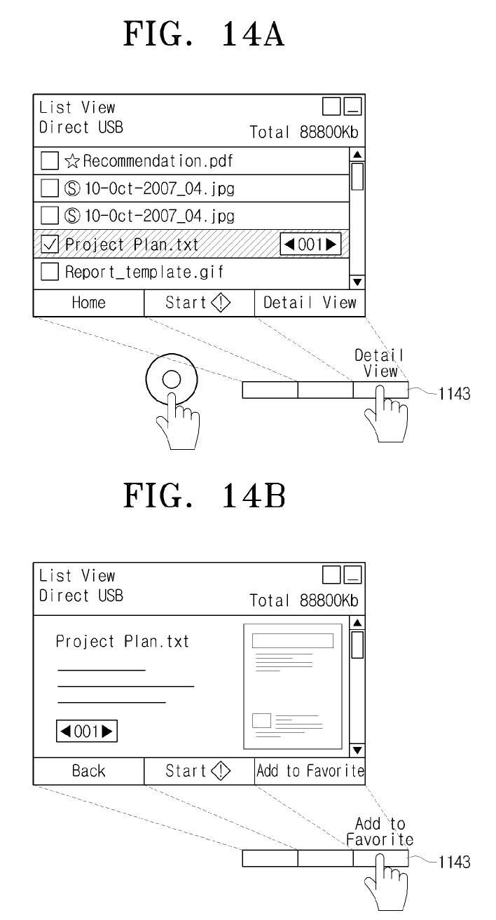

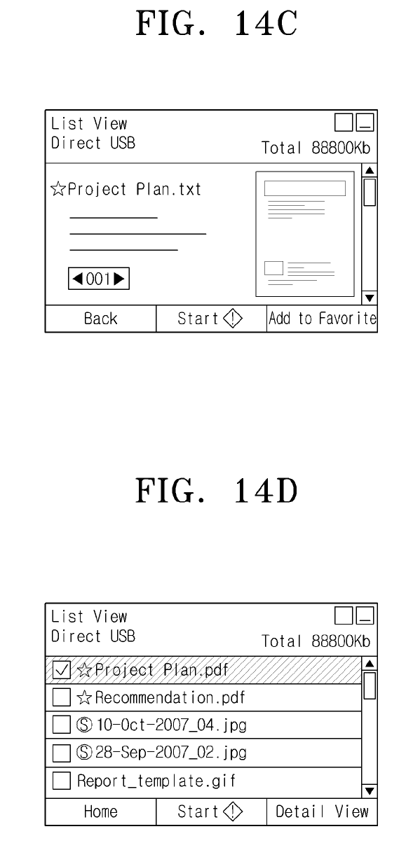

FIGS. 13A to 13C and 14A to 14D are drawings illustrating a method to add a favorite file using the panel unit 1100 of FIG. 11.

As illustrated in FIG. 13A, the user selects a desired file, Project Plan.txt, using the wheel navigation key 1120, and clicks on a button 1143 corresponding to a “Detail View” function.

Subsequently, as illustrated in FIG. 13B, the preview information of the selected file is displayed and then, if the user clicks on a button corresponding to an “Add to Favorite” function, the first identifier (tag A) is added to the selected file as illustrated in FIG. 13C. In this case, the icon ⋆ which indicates that the first identifier (tag A) is added is displayed. That is, a corresponding icon is displayed on one side of the file name.

In this exemplary embodiment, a group of favorite files are set directly by the user, but files which have been printed more than a preset number of times are automatically added to a group of favorite files.

Since FIGS. 14A to 14D are the same as FIGS. 13A to 13C, a detailed description is not repeated here.

Returning to the file list screen after the selected file is added to a group of favorite files as illustrated in FIG. 14C, the added file, ⋆ Project Plan.txt, is displayed at the top of the list as illustrated in FIG. 14D.

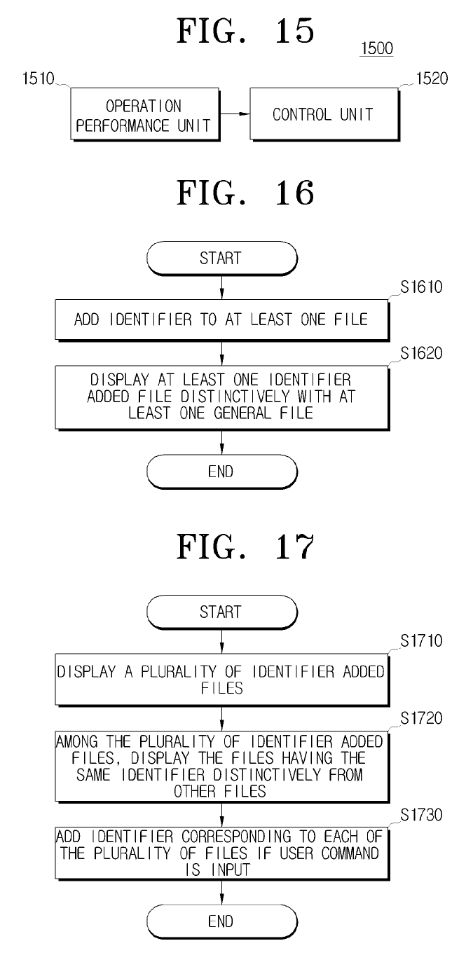

FIG. 15 is a block diagram illustrating a configuration of an identifier adding apparatus according to an exemplary embodiment of the present general inventive concept. The identifier adding apparatus 1500 includes an operation performance unit 1510 and a control unit 1520.

The operation performance unit 1510 performs a preset operation.

The control unit 1520 generates and adds a preset identifier to a file generated by the preset operation.

The preset operation may be at least one of printing, copying, scanning, faxing, and storing.

The identifier may be a single identifier corresponding to at least one of a type of operation performed by the operation performance unit 1510, the manufacturing company, and the product name.

The identifier adding apparatus 1500 may be mounted in the image forming apparatus.

FIG. 16 is a flow chart illustrating a method to display files having identifiers in an image forming apparatus according to an exemplary embodiment of the present general inventive concept.

As illustrated in FIG. 16, an identifier is added to at least one file (operation S1610). The at least one file having the identifier is displayed so as to be distinct from at least one general file (operation S1620). The identifier represents tag information which can be read or written by the image forming apparatus, and may be added according to a preset reference, for example, according to files set according to input by the user, favorite files of the user, and files processed by a particular device. However, this is just an exemplary embodiment, and can be modified or set by the user.

If an external memory is connected, the image forming apparatus may display files stored in the external memory.

If a user command to call files stored in the image forming apparatus is input, the image forming apparatus may display the files.

The image forming apparatus may display the files having the same identifier as a group.

The image forming apparatus may display the same icon on one side of the file names of the files having the same identifier. For example, an icon ⋆ may be added to the user's favorite files, and an icon \textcircled{s} may be added to the files processed by a particular image forming apparatus.

The preview information corresponding to each of the files may be displayed. The preview information may be divided according to the group and displayed so that each preview information may display the icon corresponding to the respective identifier, or the preview information of the group of files having the same identifier may display a single icon corresponding to the identifier of all the files in the group of files.

The wheel navigation key having a selecting function and a rotating function may retrieve and select at least one file from among files using at least one of the selecting function and the rotation function.

FIG. 17 is a flow chart illustrating a method to display files having identifiers in an image forming apparatus according to an exemplary embodiment of the present general inventive concept.

Files having identifiers are displayed (operation S1710), and among the files having identifiers, the files having the same identifier are displayed distinctly from other files (operation S1720). In addition, if a user command is input, an identifier corresponding to each of the files may be added (operation S1730). That is, the user can set one of the files to be a favorite file. In this case, a file which is most recently set to be a “favorite file” is positioned at the top of a list of favorite files.

In this exemplary embodiment, the present general inventive concept is applied to image forming apparatuses, but is not limited to image forming apparatuses. The present general inventive concept can be widely applied to devices which require file management and provide the user with a file list.

As can be appreciated from the above description of the diverse exemplary embodiments of the present general inventive concept, among diverse files stored in a memory, files processed by a particular device can be easily retrieved so that name recognition for the particular device can be facilitated.

In addition, a shorter time may be taken to retrieve a desired file by directly illustrating contained files on a main screen instead of showing the user the directory structure.

Moreover, when the user frequently prints a particular file, if the file is set to be a favorite file and is displayed at the top of the file list, the file does need to be retrieved. Therefore, the time taken to print the file is minimized and efficiency is increased.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a display panel unit to display at least one file having an identifier to distinguish the at least one file from at least one general file; and
a control unit to display the at least one file having the identifier distinctly from the at least one general file on the display panel unit.

2. The image forming apparatus of claim 1, wherein the at least one file is stored in at least one of a storage unit of the image forming apparatus and an external storage device which is connectable to the image forming apparatus.

3. The image forming apparatus of claim 1, further comprising an input unit,
wherein if a command to add an identifier is input through the input unit, the control unit adds the identifier to the at least one file, and
if a command to perform an operation is input through the input unit, the control unit performs the operation.

4. The image forming apparatus of claim 1, wherein the control unit displays at least one file having a same identifier so as to form a group.

5. The image forming apparatus of claim 1, wherein the control unit displays a preset icon at one side of a file name of the at least one file having the identifier.

6. The image forming apparatus of claim 1, wherein the control unit displays preview information corresponding to the at least one file.

7. The image forming apparatus of claim 1, wherein the identifier is added according to a preset reference.

8. The image forming apparatus of claim 7, wherein the preset reference is at least one of input by a user, a use history, and a file generated by a preset device.

9. The image forming apparatus of claim 1, wherein the identifier is tag information to be readable or writable by the image forming apparatus.

10. The image forming apparatus of claim 1, further comprising a wheel navigation key to include a selecting function and a rotation function, and to retrieve and select at least one file from among a plurality of files using at least one of the selecting function and the rotation function.

11. A method to display a file having an identifier in an image forming apparatus, the method comprising:
adding an identifier to at least one file;
distinguishing between the at least one file having the identifier and at least one general file; and
displaying the at least one file having the identifier distinctly from the at least one general file.

12. The method of claim 11, wherein the at least one file is stored in at least one of a storage unit of the image forming apparatus and an external storage device to be connectable to the image forming apparatus.

13. The method of claim 11, wherein if a command to add an identifier or a command to perform an operation is input, the identifier is added to the at least one file, or the operation is performed.

14. The method of claim 11, wherein at least one file having the same identifier is displayed so as to form a group.

15. The method of claim 11, wherein a preset icon is displayed at one side of a file name of the at least one file having the identifier.

16. The method of claim 11, further comprising:
displaying preview information area corresponding to the at least one file.

17. The method of claim 11, wherein the identifier is added according to a preset reference.

18. The method of claim 17, wherein the preset reference is at least one of input by a user, a use history, and a file generated by a preset device.

19. The method of claim 11, wherein the identifier is tag information to be readable or writable by the image forming apparatus.

20. The method of claim 11, further comprising:
retrieving and selecting at least one file from among a list of files using at least one of a selecting function and a rotation function of a wheel navigation key.

21. An identifier adding device, comprising:
an operation performance unit to perform a preset operation; and
a control unit to generate and add a preset identifier to a file generated by the preset operation.

22. The identifier adding device of claim 21, wherein the operation is at least one of printing, copying, scanning, faxing, and storing, and the identifier is a single identifier corresponding to at least one of a type of operation, a manufacturing company, and a device name.

23. An image forming system, comprising:
a storage unit to store a plurality of files;
an input unit to select at least one of a plurality of identifiers to correspond with one or more of the plurality of files;
a control unit to identify the files based at least on the identifiers corresponding to the files, and to arrange the files in an order based on the corresponding identifiers thereto; and
a display unit to display the files in an order based on the corresponding identifiers thereto.

24. An image forming method, comprising:
selecting at least one of a plurality of identifiers to correspond with one or more of a plurality of files;
identifying the files based at least on the identifiers corresponding to the files; and
arranging the files in an order based on the corresponding identifiers thereto.
